(19) United States
(12) Patent Application Publication
(10) Pub. No.: US 2025/0315764 A1
(43) Pub. Date: Oct. 9, 2025

(54) SYSTEM AND METHOD FOR LARGE LANGUAGE MODEL (LLM) POLICY ALERTING AND ADVISING

(71) Applicant: Wells Fargo Bank, N.A., San Francisco, CA (US)

(72) Inventors: Austin Lee Grelle, Riverside, IL (US); Guangcao Ji, Plano, TX (US); Carleton Jay Lindgren, JR., Denver, CO (US)

(21) Appl. No.: 18/625,780

(22) Filed: Apr. 3, 2024

(51) Int. Cl. G06Q 10/0637; G06F 40/20

(52) U.S. Cl. CPC G06Q 10/0637; G06F 40/20

(57) ABSTRACT

Systems and methods are provided. In one example, a method includes monitoring data stores storing policy records for changes to the policy records, and retrieving, from the data stores, the changes to the policy records. The method further includes determining, via a large language model (LLM) using the changes to the policy records, a list of one or more entities in an organization affected by the changes to the policy records, and deriving, via the LLM, an impact metric for each of the one or more affected entities. The method additionally includes identifying, via the LLM using a customizable threshold, for each of the one or more affected entities, that their impact metric exceeds the customizable threshold. The method also includes generating, via the LLM, an impact assessment report of detailing a predicted effect of the changes to the policy records, and transmitting the impact assessment report.

### TECHNICAL FIELD

The present disclosure generally relates to automated alerting and advising, and more specifically to automated alerting and advising via large language models (LLMs).

### BACKGROUND

Regulatory and other entities, for example, financial regulatory entities, provide for certain policies used to regulate certain financial transactions. For example, certain transactions are to be reported based on monetary amounts, other transactions have to be reported based on number of transactions by the same entity, and so on. Policy changes or new policies then result in differing impacts among the regulated entities.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a block diagram depicting a Large Language Model-based Alerting and Advising System (LAAS), in accordance with certain examples.

FIG. 2 is a flowchart of a process suitable for continuously monitoring certain databases for record changes (e.g., policy record changes) and for deriving, via LLM techniques, an impact of the record changes on entities in an organization, in accordance with certain examples.

FIG. 3 is a flowchart of a process suitable for using the LAAS of FIG. 1 as a guided policy drafting tool, in accordance with certain examples.

FIG. 4 is a block diagram of a transformer model used as the one or more of the LLMs of FIG. 1, in accordance with certain examples.

FIG. 5 illustrates a machine learning engine suitable for training the one or more LLMs of FIG. 1, in accordance with certain examples.

FIG. 6 is a block diagram depicting a machine suitable for executing instructions via one or more processors, in accordance with certain examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as automating a continuous analysis of large amounts of textual data via large language models (LLMs), including regulatory data, to determine effects of certain policy changes in an organization. The LLMs additionally assist with the management and adaptation of policies within the organization, such as a bank, in response to changes in external regulations and internal procedures. The LLMs serve as tools that aids various stages of policy management, from monitoring regulatory changes to alerting relevant individuals about how these changes impact their specific roles and responsibilities.

The techniques described herein provide for end-to-end support of policy development. When a new regulation is identified or based on a chat session, the LLM analyzes existing policies to identify gaps and overlaps. It then provides suggestions for policy adjustments, helping policy writers to understand the implications of the new regulation and how to amend policies accordingly. When new policies are released, instead of merely notifying that a new regulation exists, the LLM digests the information and makes determinations about its impact on current policies and procedures.

For individual users, such as those in specific roles in various entities (e.g., management roles, banking cashier roles, foreign exchange trader roles, and so on), the LLM summarizes the changes within the scope of that person's individual responsibilities. This customization ensures that the automated alerts are relevant and specific to the user's role, avoiding a one-size-fits-all approach. Users can set up personalized criteria for alerts, allowing them to be informed about changes that may not be automatically flagged for them but are still relevant to their interests or responsibilities. The LLM also includes a chat component that allows users to engage in a conversation with the system to ask questions and clarify the impact of policy changes on their specific duties. A feedback mechanism is additionally provided. The feedback mechanism provides for a system that can refine its outputs based on user interactions, such as frequently asked questions, to improve the relevance and accuracy of future alerts. The use of LLMs thus provide a more sophisticated, intelligent layer that enhances an organization's ability to maintain compliance and operational efficiency amidst a dynamic regulatory environment, including internal regulations.

As used herein, the term policy refers to a set of rules, regulations, guidelines, laws, and/or procedures used by an organization to govern its operations, employee behavior, and decision-making processes. Policies are designed to ensure consistency, compliance with legal and regulatory requirements, and alignment with the organization's goals and values. They can cover a wide range of areas, including but not limited to human resources, IT security, financial transactions, customer interactions, and workplace safety. Policies are documented and stored in one or more data stores, communicated to all relevant stakeholders within the organization, and periodically reviewed and updated to reflect changes in the organization's internal and external environment.

As user herein, the term entity refers to an organization (e.g., a regulatory body, a corporation, a legislature), a department, a group, a team, or an individual (e.g., an employee). Entities participate in the techniques described herein by authoring policies and/or by being impacted by the policies. For example, a regulatory body such as the Federal Deposit Insurance Corporation (FDIC), publishes a set of regulations that impact banking entities and that differ in impact among employee entities of the banking entity. The use of the techniques described herein enable LLMs to help draft policy changes, alert when the changes occur, and guide as to the effect of the changes, thus providing for a more efficient policy creation and implementation.

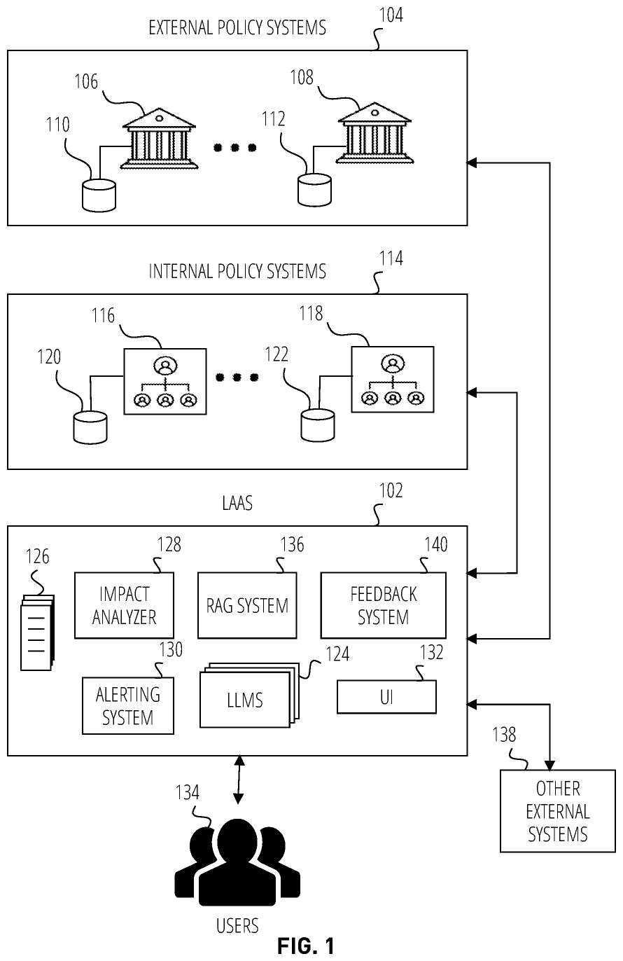

Turning now to FIG. 1, the figure is a block diagram depicting a Large Language Model-based Alerting and Advising System (LAAS) 102, in accordance with certain examples. In the depicted example, the LAAS 102 is communicatively coupled to one or more external policy systems 104, such as regulatory entities 106, legislatures 108, and other systems external to an organization. More specifically, the LAAS 102 is communicatively connected to data stores 110, 112, of the external policy systems 104. The regulatory entities 106 include entities such as the Federal Deposit Insurance Corporation (FDIC), the Securities and Exchange Commission (SEC), the Federal Communications Commission (FCC), the Consumer Financial Protection Bureau (CFPB), the Internal Revenue Service (IRS), the Financial Industry Regulatory Authority (FINRA), the Bank for International Settlements (BIS), the International Organization of Securities Commissions (IOSCO), and so on. The legislatures 108 include federal, state, county, city, and/or municipal entities that pass laws and/or regulations for their respective jurisdictions. The data stores 110, 112 include relational databases, websites, filesystems, network databases, and so on, suitable for storing policies produced or updated by the external policy systems 104.

The LAAS 102 is further communicatively connected to internal policy systems 114, such as an information technology (IT) department 116, a human resources (HR) department 118, a legal department, a compliance department, a finance department, an executive or management committee, and so on. The data stores 120, 122, store internal policy data for their respective departments, and like the data stores 110, 112, include relational databases, websites, filesystems, network databases, and so on, suitable for storing policies produced or updated by the internal policy systems 114.

During operations, the LAAS 102 will continuously (e.g., at schedule times, such as every minute, every five minutes, every hour, every day) monitor policies produced and/or updated by the external policy systems 104 and the internal policy systems 114. In certain examples, the LAAS 102 will continuously query (e.g., at scheduled times) the data stores 110, 112, 120, 122 and retrieve new and/or updated policy data records for further analysis. In some examples, agents or daemon processes are used by the LAAS 102 to continuously monitor and retrieve the new and/or updated policy data records, while in other examples, database triggers (e.g., database processes that monitor for changes to records) and similar techniques are used to provide the new and/or updated policy data records. In some examples, the external policy systems 104 and/or internal policy systems 114 may themselves automatically provide the new and/or updated policy data records to the LAAS 102 for further analysis.

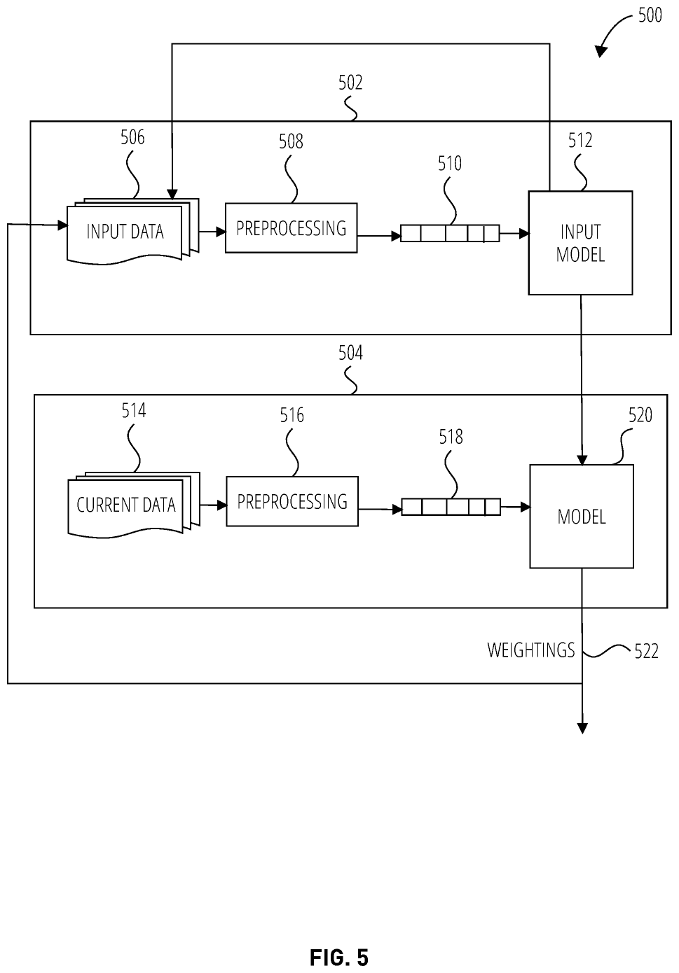

The LAAS 102 uses one or more LLMS 124 to determine if one or more entities in the organization are affected by the changes (new policies and/or updated policies). In some examples, the LLMs 124 are commercially available LLMs 124 that have been trained in a large corpus of subject matter material, including general knowledge such as history, geography, science, literature, arts, and popular culture; technology such as computer science, software development, artificial intelligence, machine learning, and emerging technologies; and business and finance such as economics, marketing, management, entrepreneurship, accounting, and financial markets, among other subject matter material. In some examples, the LLMs 124 are “homegrown” LLMs that have been trained internally, for example, using open source training data sets such as C4, common crawl, and/or Wikipedia. Further description on training and tuning of the LLMs 124 is provided with respect to FIG. 5.

In the depicted embodiment, a set of prompts 126 are used to instruct the LLMs 124 on how to determine if one or more entities in the organization are affected by the policy changes. For example, the prompts 126 include certain background section(s) such as a detailed description of employee roles (e.g., day trader, cashier, accountant, compliance office, and so on) in the organization, a description of how the roles are interconnected (e.g., IT managers report to the chief executive officer (CEO) and not the chief information officer (CIO) for certain occurrences, such as security occurrences), an organizational chart, informal chains of command, a description of the organization, and so on, further described below. The prompts 126 then instruct the LLMs 124 to find employees and/or employee roles that are impacted by the new and/or updated policies. This analysis by the one or more LLMs 124 involves parsing the natural language text of the policies to identify key terms, conditions, and any changes from previous versions. The LLMs' advanced natural language processing capabilities allow for a nuanced understanding of the policies.

Employees that are assigned to the employee roles are then considered as affected. In some examples, anonymization techniques are used, that assign employee names certain temporary identification numbers to preserve privacy and to comply with privacy laws and regulations. It is to be noted that the prompting used to determine if one or more entities in the organization are affected occurs automatically without human intervention. That is, once the prompts 126 are created, the LAAS 102 will automatically retrieve the prompts 126 after collecting the new and/or updated policy records and then execute the prompts 126, including prompt background section(s) to then derive which personnel is going to be impacted by the new and/or updated policies.

In the depicted example, an impact analyzer 128 is used to identify that the potential impacts exceed a customizable threshold. In some examples, the impact analyzer 128 uses one or more of the LLMs 124 and one or more of the prompts 126 to derive an impact metric. For example, the prompts 126 include impact metric section(s) that instruct one or more of the LLMs 124 to derive impact metrics for each employee and/or employee role. A non-limiting example prompt 126 for deriving the impact metrics is as follows: “An impact metric is defined as measuring the effect of the updates to the ‘Policy A document’ on the job and the job responsibilities for an employee or an employee role; the impact metric has values from 1 to 10, with higher values denoting a larger impact on the job and/or the job responsibilities; assign an impact metric value from 1 to 10 for employee role ‘Role A’ based on the updates to the ‘Policy A document’ and describe why the impact metric value was assigned.”

In some examples, the impact analyzer 128 automatically derives the impact metrics once the LAAS 102 has determined the list of the affected personnel. Each one of the impact metrics are then compared against a customized threshold, and if the impact metric exceeds the customized threshold, an alerting system 130 is then used to send alerts to those employee(s) whose impact metric(s) have exceeded the customized threshold. The customized threshold is customized, for example via a user interface (UI) 132. That is, a user, such as an employee, can enter a customized threshold (e.g., between 1 and 10) used to alert the user that a new and/or an updated policy has been determined as impacting their job and/or job responsibilities beyond the customized threshold. In some examples, the customized threshold is set based on the organization's criteria for significance, which could be related to financial, operational, legal, or other considerations.

The alerting system 130 will then transmit (e.g., via email, text, direct message, and so on) an alert to users 134 that have been determined as having a job and/or job responsibility impacted by the new and/or updated policy beyond their customized threshold. The transmitted alert includes the derived impact metric, as well as a textual explanation of the reasons for the impact as derived by the one or more LLMs 124. In some examples, a link to the UI 132 is also provided, that initiates a chat session with the one or more LLMs 124 to ask for more detailed information. That is, the one or more LLMs 124 include a session identification (session ID) that is provided via the link to the UI 132 to access a customized session that was used to derive the impact metric and the LLMs 124 “reasoning” for the impact. The user can then interact with the one or more LLMs 124 to get further clarification as to the policy impact on their job.

The LAAS 102 is also used for creation of new policies as well as for updates to existing policy. In a new policy authoring mode, users 134 start by accessing the LAAS UI 132, where they can select an option to create a new policy. The LAAS 102 may prompt the user to input a policy title, the scope of the policy (e.g., department or process it applies to), policy goals, and any initial thoughts or requirements they have for the policy. The LAAS 102, utilizing the one or more LLMs 124, can provide a structured template or guiding questions to help the user articulate the policy's purpose, scope, and key provisions. As the user inputs information, the LLMs 124 can generate draft text for the policy, suggesting language based on best practices, regulatory requirements, and the organization's existing policy framework. Before finalizing the draft, the users 134 can leverage the LAAS's impact analyzer 128 to predict the potential implications of the new policy on various entities within the organization. This step helps identify any unintended consequences or areas where the policy might conflict with existing policies.

The users 134 then review the draft policy generated by the LLMs 124, making adjustments as needed. The LAAS 102 can facilitate iterative refinement by suggesting alternative phrasings, highlighting areas that may require further clarification, and ensuring compliance with relevant regulations. The LAAS 102 can support collaboration by allowing the user to share the draft policy with stakeholders for feedback directly within the system. Stakeholders can provide comments and suggestions, which the LAAS 102 can help incorporate into the policy draft. Once the policy draft has been reviewed and refined, the users 134 can finalize and publish the policy through the alerting system 130, which can automatically notify affected entities and update the organization's policy database.

In an existing policy update mode, the users 134 access the LAAS UI 132 and choose an existing policy to update. The LAAS 102 retrieves the current version of the policy for editing. The users 134 makes changes to the policy text directly in the LAAS UI 132. As changes are made, the one or more LLMs 124 can suggest modifications for clarity, consistency, and compliance. The LAAS 102 then performs an impact analysis using the impact analyzer 128 on the proposed changes, highlighting how they might affect different parts of the organization and identifying any potential conflicts with other policies. Similar to the process for creating new policies, the users 134 review the changes, collaborates with stakeholders, and finalizes the updated policy. The LAAS 102 then track versions and changes, ensuring a clear audit trail of policy evolution.

The LAAS 102 additionally includes a retrieval augmented generation (RAG) system 136. The RAG system 136 accesses a variety of external systems or data sources 138, which may include regulatory databases, legal documents, industry news, and other relevant information repositories not found in the systems 104 and 114. Based on the context of the policy or the specific inquiry being analyzed by the LAAS 102, the RAG system 136 generates queries to search for pertinent information in the external. The RAG system 136 retrieves documents or data snippets that match the queries, ensuring that the most relevant and up-to-date information is brought into the analysis process. Once the relevant external data is retrieved, the RAG system 136 analyzes the content to extract key facts, figures, and insights that are pertinent to the policy under review, or the specific question being addressed. Additionally, the RAG system 136 integrates the insights derived from the external data with the inputs (e.g., new and/or updated policies) given to the LLMs 124. This combined input serves as a richer, more contextually enhanced dataset for generating outputs. By leveraging both the LLMs 124 capabilities and the external data provided via the RAG system 136, the LAAS 102 produces more comprehensive, accurate, and insightful analyses, reports, or alerts. This could include detailed impact assessments, policy change summaries, or tailored advisories for specific groups or individuals.

After receiving an output from the LAAS 102 (e.g., a policy change alert or an impact assessment), users are prompted to provide feedback on the usefulness, accuracy, and clarity of the information via a feedback system 140. The feedback collected can include ratings (e.g., star ratings), binary responses (useful/not useful), or open-ended comments. The feedback system 140 aggregates and analyzes the collected feedback to identify patterns, trends, and areas for improvement. This analysis can be performed using natural language processing techniques to understand the sentiment and content of open-ended comments. The feedback system 140 can also track feedback metrics over time to monitor changes in user satisfaction and the effectiveness of the LAAS outputs. Insights derived from the feedback analysis are then used to refine and adjust the LAAS 102. This could involve retraining the LLMs 124 with new data, tweaking the algorithms that generate outputs, or modifying the user interface for better clarity and usability.

A practical application of the LAAS 102 can be found in the context of a financial organization such as a bank, which adheres to a complex and changing regulatory environment. The LAAS 102 can be used to streamline the bank's compliance processes by providing timely updates and impact assessments to various stakeholders within the organization. In summary, the LAAS 102 is set up to continuously monitor databases that store the internal policy records as well as external databases containing regulatory updates, for example, from financial authorities. When a regulatory update occurs, the LAAS 102 retrieves the changes and uses its LLMs 124 to analyze the text of the new regulation, comparing it, for example, against the bank's existing policies to identify discrepancies or areas requiring updates. The LLMs 124 determine which departments, teams, or products within the bank are affected by the regulatory changes. For example, a change in anti-money laundering (AML) regulations would affect the compliance and customer onboarding teams. For each affected entity, such as an individual employee, the LAAS 102 derives the potential impact of the regulatory change. This might include the need for additional training, updates to customer due diligence procedures, or revisions to reporting processes. The bank sets customizable thresholds within the LAAS 102 to identify significant impacts that warrant immediate action. For instance, a change that could lead to a high risk of non-compliance or financial loss would carry a lower threshold so as to trigger an alert even on smaller impacts. The LAAS 102 then generates detailed impact assessment reports for each affected entity, outlining the necessary actions, timelines for compliance, and any potential risks. The impact assessment reports are transmitted to the relevant stakeholders, such as the individual employees, department heads, compliance officers, and executive management, ensuring that they are informed and can take appropriate action. Stakeholders can provide feedback on the reports, which the LAAS 102 uses to refine its future analyses and alerts, creating a feedback loop that improves the system's accuracy and relevance over time. It is to be understood that while the practical application is described in terms of a banking application, similar applications exist in other areas, such as but not restricted to manufacturing, insurance, software development, logistics, and so on.

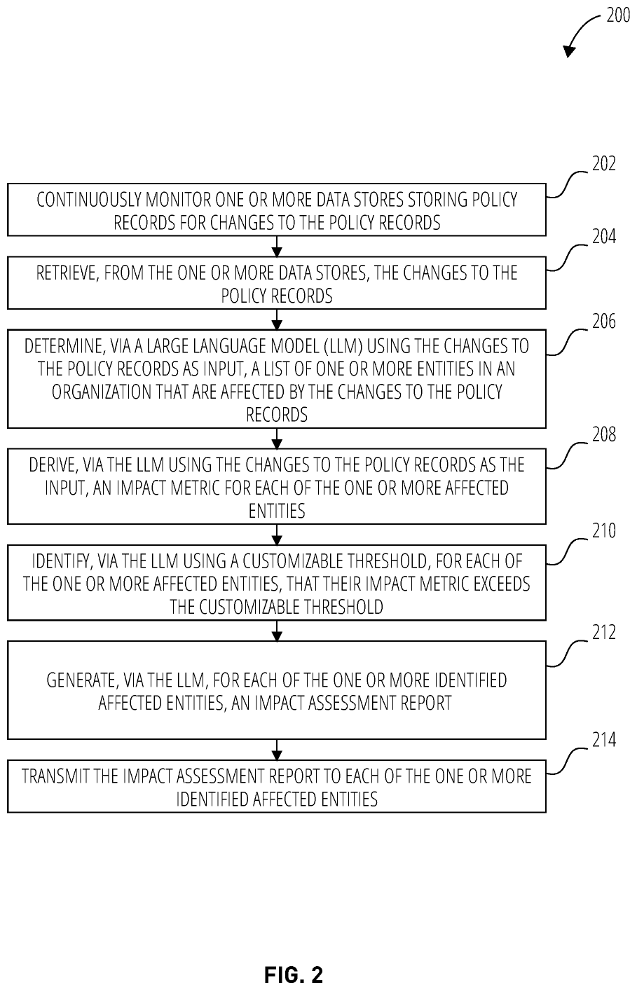

FIG. 2 is a flowchart of a process 200 suitable for continuously monitoring certain databases for record changes (e.g., policy record changes) and for deriving, via LLM techniques, an impact of the record changes on entities in an organization, such as individual employees, departments, sub-departments, and so on, in accordance with certain examples. The process 200 is used, for example, to implement the LAAS 102, thus resulting in a practical application of the techniques described herein.

In the depicted example, the process 200, at block 202, continuously monitors one or more data stores storing policy records for changes to the policy records. The data stores include the internal policy data stores 120, 122, such as IT data stores, HR data stores, and the like as well as external policy data stores 110, 112, such as regulatory system data stores. The monitoring at block 202 includes using agents or process daemons to query the internal and external policy data stores 110, 112, 120, 122 for any new policy and/or updates to policy records. The monitoring also includes using database techniques, such as triggers, to submit new and/or updated policy records when the data stores 110, 112, 120, 122 experience a change.

The process 200, at block 204, then retrieves from the one or more data stores 110, 112, 120, 122, the one or more new and/or updated policy records. The one or more new and/or updated policy records include Anti-Money Laundering (AML) records such as enhanced due diligence procedures for high-risk customers, including politically exposed persons (PEPs) and entities from jurisdictions with weak AML controls. Other non-limiting example policy records include remote work policy change records, data privacy regulation compliance records, cybersecurity directives, environmental, social, and governance (ESG) initiatives records, client complaint resolution process update records, insider trading policy revisions, and so on. Retrieval of the records at block 204 includes using structure query language (SQL), file retrievals via systems using file transfer protocol (FTP), batch retrieval of records, and so on. It is to be noted that the retrieval of records at block 204 is automatic. That is, the LAAS 102 automatically retrieves the records on a schedule or when automatically notified (e.g., via database triggers), of the presence of new and/or updated policy records.

The process 200 then automatically determines, at block 206, via one or more large language model (LLMs) that are giving the policy records retrieved at block 204 as input, a list of one or more entities in an organization that are affected by the changes to the policy records. In one example, LLM prompt(s) (e.g., prompts 126) are automatically provided to the one or more LLMs so as to direct the LLM to determine the list of entities that are affected by the new and/or updated policy records. The LLM prompts instruct, through textual instructions to analyze the new and/or updated policy records and then determine the list of impacted entities. In a simple example, a textual instruction would include “analyze the updated ‘Policy A’ and derive a list of affected employees of ‘Organization B’ from the ‘Employee List C.’ The one or more LLMs are aided in the analysis by using, in some examples, background text during the prompting. The background text includes, for each employee, a detailed description of the employee's roles, jobs, duties, and responsibilities in the organization. In a simplified example, for employee ‘John’, a level 1 cashier, the background text includes a description such as “Operate retail store product checkout equipment (e.g., cash registers, credit/debit card terminals, scanners); collect payments and help with bagging purchases; maintain accurate count of cash receipts; balance cash register and provide appropriate transaction reports; assist customers with product recommendations, directions to product store locations; keep checkout areas and workspace clean to ensure efficient processing.” Similar background text is provided to describe functions, roles and/or responsibilities of other non-employee entities, such as departments, sub-departments, groups, and so on.

In some examples, the RAG system 136 is additionally or alternatively used to retrieve external data useful in determining the list of affected entities. For example, the RAG system 136 is used to extend a knowledge base of the LLMs 124 to certain domains, such by adding deep knowledge of the organization and the organization's employees (e.g., organizational structure, employee job duties, department functions, and so on) through retrieval of organizational data (e.g., employee and job background text, department functions and duties, organizational charts, organizational procedures and processes, and other forms of organizational knowledge). The organizational data is then added to the LLMs 124 knowledge base. In certain examples, the LLMs 124 are fine tuned (e.g., further trained) via the organizational data to extend their domain expertise, to add the deep knowledge of the organization and the organization's entities.

At block 208, process 200 derives, via the LLM using the changes to the policy records as the input, an impact metric for each of the one or more affected entities. In some examples, the LLM prompts 126 are used to instruct the LLMs 124 to output an impact metric based on a predefined scale (e.g., 1 to 10) for each affected entity at block 206. An example textual prompt for an employee entity include “An impact metric is defined as measuring the effect of the updates to the ‘Policy A document’ on the job and the job responsibilities for an employee or an employee role; the impact metric has values from 1 to 10, with higher values denoting a larger impact on the job and/or the job responsibilities; assign an impact metric value from 1 to 10 for employee ‘A’ based on the updates to the ‘Policy A document’. Similar prompts are used for departments, groups, employee roles, and the like. The LLMs 124 then will output the impact metric.

The process 200, at block 210, process 200 identifies, via the LLM using a customizable threshold, for each of the one or more affected entities, that their impact metric exceeds the customizable threshold. That is, a user can customize a default threshold so that the LAAS 102 can better gauge, for example, the importance of an impact due to certain policies, regulations, and so on. For example, impacts of Anti-Money Laundering (AML) policies may be given a lower customizable threshold so that even slight impacts due to changes are automatically analyzed and disseminated to affected members of the organization. In one non-limiting example, an AML department may set their AMP policy change threshold to 1, while an HR department may set their AMP policy change threshold to 8. Accordingly, AML policy changes will exceed the AML department threshold more often than the HR department threshold. It is to be noted that more than one customizable threshold can be used by each entity. For example, an employee can set up a customizable threshold for AML policy changes, another for HR policy changes, and yet another for IT policy changes.

In block 212, process 200 generates, via the LLM, for each of the one or more identified affected entities, an impact assessment report of a predicted effect of the changes to the policy records. For example, LLMs 124 are provided prompts 126, such as textual prompts that instruct the LLMs 124 to analyze the policy changes for each affected entity (e.g., employees, departments, groups, and so on) having an impact metric over their customizable threshold. For example, a prompt can include “Describe in detail the impact of changes to ‘Policy A’ to ‘Employee B’ in terms of job duties, responsibilities, and related job matters.” In certain examples, for each identified group or individual, impact analyzer 128 generates customized impact assessment reports via the LLMs 124. These impact assessment reports highlight the specific implications of the policy changes, taking into account the unique attributes or responsibilities of the group or individual. The customization ensures that the impact assessment reports are relevant and actionable. In block 214, the process 200 transmits the impact assessment report to each of the one or more identified affected employees. For example, emails, text messages, and other communication can be sent to notify the impacted entities of the upcoming policy changes.

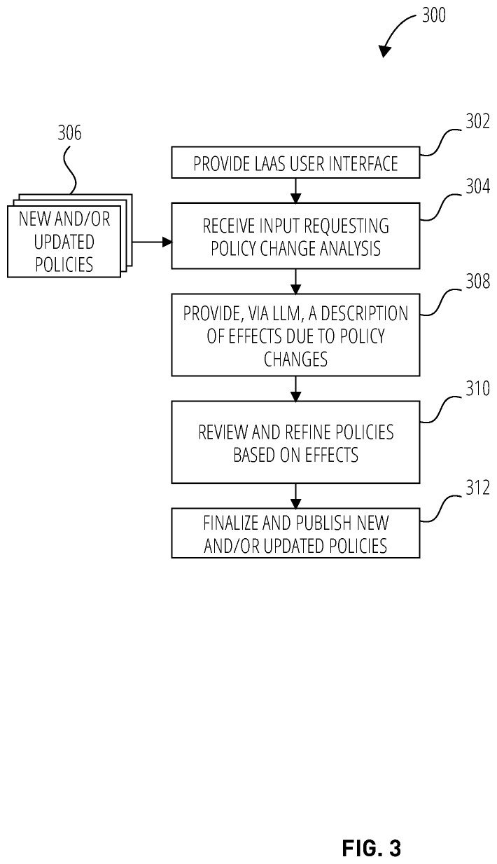

The techniques described herein also provide for the ability to better understand the effects of certain policy changes, for example, during authoring of the policy changes. Turning now to FIG. 3, the figure is a flowchart of a process 300 suitable for using the LAAS 102 as a guided policy drafting tool, in accordance with certain examples. In the depicted example, the process 300, at block 302, provides for a chat interface to directly access the LAAS 102. For example, the UI 132 provides for an interface to enter text into the LAAS 102 and to receive LAAS 102 output. In some examples, the interface is a graphical user interface. Additionally or alternatively, the interface includes an application programming interface (API) suitable for programmatic operations of the LAAS 102 via function calls and the like.

The process 300, at block 304, then receives input, such as text input, a request for a policy change analysis. The request includes a new policy and/or changes to an existing policy 306. The is, the LAAS 102 is asked to analyze the effects on an organization of the new and/or updated policies 306. In some examples, the request may specify a specific department, group, and/or organization to focus on for the analysis.

The process 300 then provides, at block 308, a description of effects of the new and/or updated policies 306. In one example, the impact analyzer 128 is used to provide, via the LLMs 124, the potential effects of the new and/or updated policies 306 on various entities within the organization. That is, a customized impact assessment report highlighting the implications of the new and/or updated policies 306 is produced at block 308, taking into account the unique attributes or responsibilities of the group or individual. This step helps identify any unintended consequences or areas where the policy might conflict with existing policies. During policy creation or change—before the change is made, the LLMs 124 can identify that the change is going to or is likely going to trigger x % of employees' alerts. For example, during a change to the work from home policy, an ambiguous change (e.g., “three days in the office on average”) is introduced. The LLMs 124 predict that the change will trigger 85% of employees alerting systems, so the user likely will then edit the policy. The LLMs 124 can suggest a change (e.g., “average per month”) for clarity, which may lower the trigger to 50% of employees LLMs 124 triggering, for example. As mentioned above, the LLMs 124 can be accessed in a question/answer format via the UI 132, such as through a chat session.

The process 300, at block 310 reviews and refines the new and/or updated policies 306 based on the effects found at block 308. For example, the processes 300 provides iterative refinement by suggesting, via the LAAS 102, alternative phrasings, highlighting areas that may require further clarification, and ensuring consistency and compliance with relevant regulations or other policies. The user can, for example, ask the LAAS 102 to suggest changes to the new and/or updated policies 306 to minimize (or to maximize) certain effects in the organization, including inconsistencies and non-compliance with existing policy. The LAAS 102 can support collaboration by allowing the user to share the draft policy with stakeholders for feedback directly within the system. Stakeholders can provide comments and suggestions, which the LAAS 102 can help incorporate into the policy draft. Once the policy draft has been reviewed and refined, the process 300, finalizes and publishes, at block 312, the revised policy through the LAAS 102, which can automatically notify affected entities and update the organization's policy database.

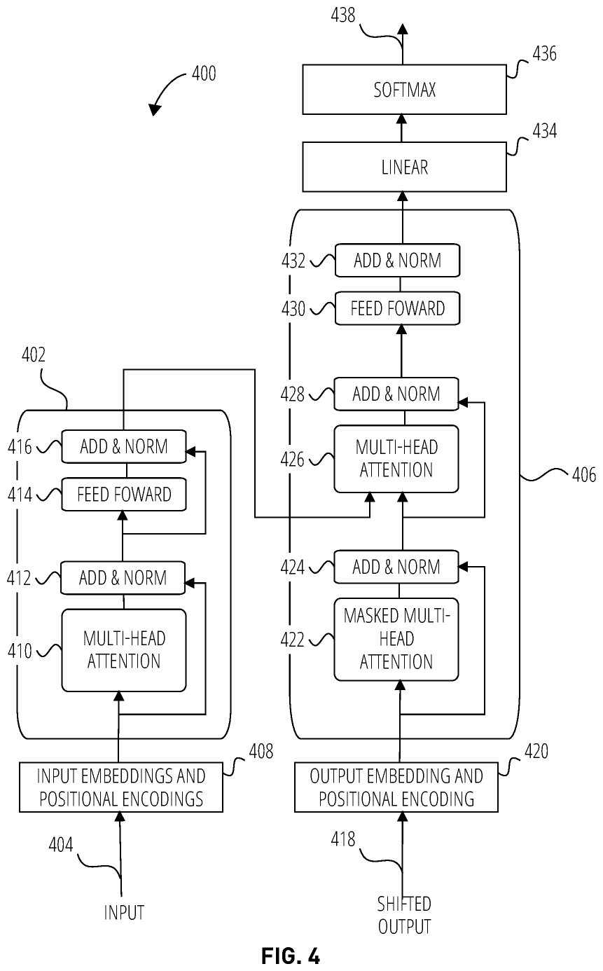

It may be beneficial to describe an architecture used for one or more of the LLMs 124. Turning now to FIG. 4, the figure is a block diagram of a transformer model 400 used as one or more of the LLMs 124, in accordance with certain examples. In the depicted example, an encoder 402 maps an input 404 (e.g., input tokens or words in a sentence) into a sequence of continuous representations to be fed into a decoder 406. That is, the encoder 402 converts the input 404 into a continuous representation that retains the semantic information or meaning of the input 404. This process involves embedding the tokens into a high-dimensional space. For example, input embeddings and positional encodings 408. Input embeddings transform discrete input 404 elements, such as words in a sentence, into continuous vector representations. These vectors are learned during the training process and capture semantic and syntactic properties of the tokens. This process allows the transformer model 400 to work with the input data in a more mathematical and computationally efficient manner.

Since the transformer model 400 does not inherently understand the order of tokens in the sequence, positional encodings are added to the input embeddings to provide information about the position of each token in the sequence. This helps the transformer model 400 to maintain the sequence's order and understand the relative positions of tokens. The multi-head attention block or layer 410 in the encoder of a transformer model is a mechanism designed to enable the model to focus on different parts of the input sequence simultaneously, capturing various aspects of the information contained within. This informs the understanding of more complex relationships and dependencies in the data, such as the syntactic and semantic nuances in natural language processing tasks. Unlike recurrent neural networks, the multi-head attention block or layer 410 (e.g., attention mechanism) processes all positions simultaneously via multiple “heads,” making it highly parallelizable and more efficient, especially for longer input sequences.

After obtaining the output from each head, a concatenation all the heads' outputs is then performed. An add & normalize block or layer 412 is then used for residual connection (add) and layer normalization (norm). Residual connections help to mitigate a vanishing gradient problem, which can be prevalent in deep networks. By adding the input directly to the output, the gradient has a shortcut path during backpropagation, making it easier to train very deep networks. Residual connections can be thought of as allowing the transformer model 400 to learn modifications to an identity function rather than learning the entire transformation. This can potentially make learning more efficient, as the model can focus on the changes or “residuals” needed. The layer normalization helps in stabilizing the learning process by ensuring that the outputs of the layers have a mean of 0 and a standard deviation of 1. This consistency can significantly improve the training speed and stability of deep neural networks.

The feed forward block or layer 414 consists of a position-wise fully connected feed-forward network that is applied to each position separately and identically. This means that the same feed-forward network is used for each position in the sequence, but it operates independently on each position. The purpose of the layer 414 is to introduce additional non-linearity into the model, allowing it to learn more complex patterns beyond what can be captured by the attention mechanism alone. A second add & normalize block or layer 416 is also shown, similar to the first add & normalize block or layer 412. The second add & normalize block or layer 416 also incorporates a residual connection. This time, the residual connection adds the output of the feed-forward network 414. This mechanism helps in preventing the vanishing gradient problem and allows for deeper models by facilitating the flow of gradients. Output of the add & normalize block or layer 416 is then sent to the decoder 406.

The decoder 406 processes the encoder output alongside its own input 418 (which, during training, is a target sequence shifted by one position to the right, indicating the next expected token). The decoder's architecture mirrors that of the encoder 402 but includes an additional attention mechanism to focus on appropriate parts of the encoder output. More specifically, the decoder 406 processes its input 418 by first converting it into embeddings and then adding positional encodings 420. This step ensures that the transformer model 400 maintains information about the order of tokens in the sequence 418.

The first block or layer is a masked multi-head attention block or layer 422. However, unlike in the encoder 402, this multi-head attention block or layer 422 is masked to prevent positions from attending to subsequent positions. This masking ensures that the predictions for position i can only depend on the known outputs at positions less than i, maintaining an autoregressive property of the decoder 406. An add & normalize block or layer 424 is then used, which as mentioned previously helps in stabilizing the training process and facilitates deeper models. A second, unmasked multi-head attention block or layer 426 is then used, in which the inputs (e.g., queries) come from the output of the add & normalize block or layer 424, and the keys and values come from the output of the encoder 402. This allows the decoder 406 to focus on different parts of the input sequence 404 as needed, based on the context provided by its own output 418 so far.

Another add & normalize block or layer 428 is then used, which aids in stabilizing training, as mentioned earlier, via residual connection and layer normalization. The add & normalize block or layer 428 provides its output to a feed forward block or layer 430. The feed forward block or layer 430 allows the transformer model 400 to learn more complex functions beyond what is captured by the attention layers 422, 426. While the attention layers 422, 426 help the transformer model 400 to focus on different parts of the input sequence and “understand” the relationships between them, the feed forward layer 430 provides the capacity to transform these relationships into a higher-level representation. Unlike the attention layers 422, 426 that operate on the entire sequence simultaneously to capture relationships between elements, the feed forward layer 430 processes each position independently. This design ensures that the transformer model 400 can apply the same transformation across different positions, allowing it to maintain a consistent approach to feature extraction and transformation across the sequence.

Output of the feed forward layer 430 is then provided to an add & normalize block or layer 432, which again aids in stabilizing training via residual connection and layer normalization. The add & normalize layer 432 then provides its output to a linear block or layer 434. The linear layer 434 transforms the high-dimensional representations output by the decoder's last layer into a vector of logits. Each logit corresponds to a score for each token in the model's vocabulary. The dimension of this output vector is equal to the size of the vocabulary. Being fully connected, the linear layer 434 connects each input feature to each output logit, ensuring that all aspects of the internal representation can contribute to the prediction of each token.

Following the linear transformation, a softmax block or layer 436 is applied to the logits to convert them into a probability distribution. Each element in this distribution represents the probability of a corresponding token being the next token in the sequence. The token with the highest probability can then be selected as an output 438 at each step in the sequence generation process. In sequence-to-sequence tasks, such as machine translation, text summarization, or even in generative tasks like text completion, the transformer model 400 iteratively generates the output sequence one token at a time, using the probabilities provided by the softmax layer 436 after the linear transformation at layer 434.

In some examples, the LLMs 124 include the architecture of the transformer model 400 and/or derivatives (e.g., encoder 402 only, decoder 406 only). Inputs 404, such as the prompts 126, are provided to the transformer model 400 via the UI 132. As mentioned earlier, the UI 132 includes a GUI and/or an API. The transformer model 400 then produces as output, for example, policy impact assessment reports, list of affected employees, suggestions to revise draft policies, and so on. By using generative AI techniques, such as via the transformer model 400, the LAAS 102 enables a more efficient and effective policy change alerting and policy drafting.

FIG. 5 illustrates a machine learning engine 500 suitable for training the one or more LLMs 124 of the LAAS 102, in accordance with certain examples. The machine learning engine 500 may be deployed to execute at a mobile device (e.g., a cell phone), a computer, a server, a cloud-based system, and so on. In some examples, a system, such as the LAAS 102, may calculate one or more weightings for criteria based upon one or more machine learning algorithms via the machine learning engine 500, used in training the transformer model 400 of FIG. 4.

In the depicted example, the machine learning engine 500 uses a training engine 502 and a prediction engine 504. The training engine 502 uses input data 506, for example after undergoing preprocessing via the preprocessing component 508, to determine one or more features 510. The one or more features 510 may be used to generate an initial input model 512, which may be updated iteratively or with future labeled or unlabeled data (e.g., during reinforcement learning or fine tuning).

For the transformer model 400, the input data 506 includes a large corpus of subject matter material, including general knowledge such as history, geography, science, literature, arts, and popular culture; technology such as computer science, software development, artificial intelligence, machine learning, and emerging technologies; and business and finance such as economics, marketing, management, entrepreneurship, accounting, and financial markets, among other subject matter material. In some examples, open source training data sets such as C4, common crawl, and/or Wikipedia are used as the input data 506. Fine tune training includes using detailed knowledge of an organization that will be using the LAAS 102. The detailed knowledge includes organizational structure, organizational functions, organization's responsibilities, organization's duties, organization's mission, department descriptions, department functions, department responsibilities, department duties, employee job description, employee responsibilities, employee duties, organizational charts, organizational procedures and processes, department procedures and processes, employee procedures and processes, and other forms of organizational knowledge.

In the prediction engine 504, current data 514 may be input to preprocessing component 516. In some examples, preprocessing component 516 and preprocessing component 508 are the same. The prediction engine 504 produces feature vector 518 from the preprocessed current data, which is input into the model 520 to generate one or more criteria weightings 522. The criteria weightings 522 may be used to output a prediction, as discussed further below.

The training engine 502 may operate in an offline manner to train the model 520 (e.g., on a server). The prediction engine 504 may be designed to operate in an online manner (e.g., in real-time, at a mobile device, on a wearable device, etc.). In some examples, the model 520 may be periodically updated via additional training (e.g., via updated input data 506 or based on labeled or unlabeled data output in the weightings 522) or based on identified future data, such as by using reinforcement learning to personalize a general model (e.g., the initial model 512) to a particular user and/or organization. Labels for the input data 506 may include organizational labeling of certain knowledge, including anonymous labeling, e.g., “employee A.”

The initial model 512 may be updated using further input data 506 until a satisfactory model 520 is generated. The model 520 generation may be stopped according to a specified criteria (e.g., after sufficient input data is used, such as 500,000, 1 million, 2 billion data points, etc.) or when data converges (e.g., similar inputs produce similar outputs).

The specific machine learning algorithm used for the training engine 502 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 502. In an example embodiment, a regression model is used and the model 520 is a vector of coefficients corresponding to a learned importance for each of the features in the vector of features 510, 518. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like. Once trained, the model 520 may now correspond to the trained transformer model 400.

By virtue of the training, the trained transformer model 400 now includes a knowledge base in the form of learned representations. That is, through training, the LLMs 124 develop intricate representations of language that capture deeper semantic meanings, relationships between concepts, and contextual nuances. These representations enrich the LLMs' knowledge bases, enabling it to understand and generate complex, nuanced responses. In some embodiments, further training on specific areas, also known as fine tuning, is applied. For example, descriptions of the organizational structure (e.g., based on an org chart), organizational functions, organizational duties, organization roles, employee job duties, department functions, group functions, and so on, is entered into the LLMs' knowledge bases via training.

In some examples, the LLMs' knowledge bases are added when prompting the LLMs. For example, in addition to prompt instructions, the LLMs 124 are provided one or more documents along with the instructions. The documents include descriptions of the organizational structure (e.g., based on an org chart), organizational functions, organizational duties, organization roles, employee job duties, department functions, group functions, and so on. As mentioned earlier the RAG system 126, in some examples, is also used to add to the LLMs' knowledge bases. The RAG system 126 queries data stores that include descriptions of the organizational structure (e.g., based on an org chart), organizational functions, organizational duties, organization roles, employee job duties, department functions, group functions, and so on, to then add to the LLMs' knowledge base.

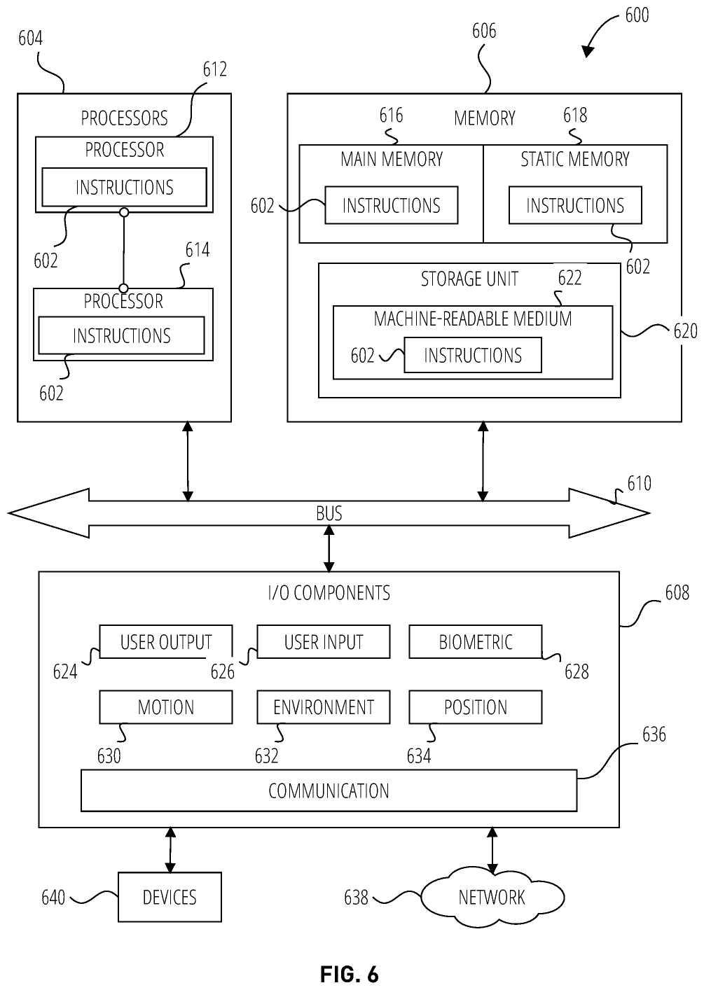

FIG. 6 is a diagrammatic representation of a machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the processes or methods described herein, such as the process 200 and 300. The instructions 602 transform the general, non-programmed machine 600 into a particular machine 600, e.g., the LAAS 102, programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. In some examples, the machine 600 may also comprise both client and server systems, with certain operations of a particular method or algorithm being performed on the server-side and with certain operations of the particular method or algorithm being performed on the client-side.

The machine 600 may include processors 604, memory 606, and input/output I/O components 608, which may be configured to communicate with each other via a bus 610. In an example, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 612 and a processor 614 that execute the instructions 602. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single-core, a single processor with multiple cores (e.g., a multi-core processor), multiple processors with a single core, multiple processors with multiples cores, or any combination thereof.

The memory 606 includes a main memory 616, a static memory 618, and a storage unit 620, both accessible to the processors 604 via the bus 610. The main memory 616, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 608 may include biometric components 628, motion components 630, environmental components 632, or position components 634, among a wide array of other components. For example, the biometric components 628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 634 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 further include communication components 636 operable to couple the machine 1200 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a universal serial bus (USB) port), internet-of-things (IoT) devices, and the like.

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

The techniques described herein provides a generative AI approach to policy alerting, policy drafting, and policy management, offering organizations a proactive, intelligent, and customizable solution for navigating the complexities of policy changes. By leveraging the capabilities of a Large Language Model (LLM), the system continuously monitors one or more databases for changes to policy records, retrieves these changes, and utilizes the LLM to analyze the implications of these changes on various entities within the organization. The LLM identifies which entities are affected by the policy changes. It does so by processing the changes as input and deriving a potential impact for each affected entity. The system is designed to identify entities whose potential impact exceeds a customizable threshold, ensuring that only the most pertinent changes are flagged for further attention. Once the system identifies the affected entities, it generates an impact assessment report for each one. This report is not a mere notification but a comprehensive analysis that outlines the implications of the policy changes, providing actionable insights for the recipients. The LLM's sophisticated understanding of language and context allows it to produce reports that are tailored to the specific needs and functions of each entity, thereby enhancing the relevance and utility of the information provided.

What is claimed is:

1. A method, comprising:
monitoring one or more data stores storing policy records for changes to the policy records;
retrieving, from the one or more data stores, the changes to the policy records;
determining, via a large language model (LLM) using the changes to the policy records as input, a list of one or more entities in an organization that are affected by the changes to the policy records;
deriving, via the LLM using the changes to the policy records as the input, an impact metric for each of the one or more affected entities;
identifying, via a processor using a customizable threshold, for each of the one or more affected entities, that their impact metric exceeds the customizable threshold;
generating, via the LLM, for each of the one or more identified affected entities, an impact assessment report detailing a predicted effect of the changes to the policy records; and
transmitting, via the processor, the impact assessment report to each of the one or more identified affected entities.

2. The method of claim 1, wherein determining, via the LLM using the changes to the policy records as the input, the list of the one or more entities comprises:
automatically providing the LLM the changes to the policy records as input;
automatically instructing the LLM, via a LLM prompt, to analyze the changes to the policy records and to derive a potential impact based on the analysis; and
automatically using the potential impact when deriving, via the LLM, the impact metric for each of the one or more affected entities.

3. The method of claim 2, wherein the LLM prompt comprises a section describing the organization's structure and departments, employee job descriptions, department functions, and department roles, to add to a knowledge repository of the LLM.

4. The method of claim 2, further comprising providing as input to the LLM, via a retrieval augmented generation (RAG) system, the organization's structure and departments, employee job descriptions, department functions, and department roles, to add to a knowledge repository of the LLM.

5. The method of claim 2, further comprising fine tuning the LLM, based on additional training, to add the organization's structure and departments, employee job descriptions, department functions, and department roles, to add to a knowledge repository of the LLM.

6. The method of claim 1, wherein at least one of the one or more affected entities comprises an employee of the organization and wherein the impact assessment report comprises a customized impact assessment report describing how the changes to the policy records affect the employee's job procedures, job duties, job responsibilities, or combination thereof, within the organization.

7. The method of claim 1, wherein at least one of the one or more affected entities comprises a department of the organization and wherein the impact assessment report comprises a customized impact assessment report describing how the changes to the policy records affect the department's procedures, responsibilities, or combination thereof, within the organization.

8. The method of claim 1, wherein the deriving of the impact metric for each of the one or more affected entities comprises using one or more LLM prompts that instruct the LLM to assign an impact metric value based on a predefined scale, where the scale ranges from a lower value indicating a lesser impact to a higher value indicating a greater impact on the entity's role or responsibilities in the organization.

9. The method of claim 1, wherein the generating of the impact assessment report comprises providing a detailed explanation of reasons for the predicted effect, as derived by the LLM, and wherein the impact assessment report further comprises a suggestion for actions to be taken by the affected entities to comply with or adapt to the changes in the policy records.

10. The method of claim 1, further comprising refining the LLM's outputs based on a user feedback to improve a relevance and accuracy of future impact assessment reports, wherein the user feedback comprises user ratings, binary responses, or open-ended comments regarding the usefulness, accuracy, clarity, or a combination thereof, of information provided in the impact assessment reports.

11. The method of claim 1, further comprising:
providing a user interface (UI) to access the LLM;
receiving, via the UI, a request for an analysis of a new policy draft; and
generating, via the LLM, a description of effects of the new policy draft, wherein the description includes a potential impact of the new policy draft on various entities within the organization.

12. The method of claim 11, further comprising:
receiving, via the UI, a second request to generate a revision to the new policy draft;
generating, via the LLM, the revision to the new policy draft; and
generating, via the LLM, a second description of second effects of the new policy draft and the revision, wherein the description includes a second potential impact on the various entities within the organization.

13. The method of claim 12, wherein the effects of the new policy draft comprise a non-compliance or an inconsistency with an existing policy, and wherein the second request comprises an LLM prompt to resolve the non-compliance or the inconsistency via the revision.

14. The method of claim 1, wherein the monitoring comprises using an agent, a process daemon, or a combination thereof, to query the data stores for a new policy record, update to a policy record, or a combination thereof.

15. The method of claim 1, wherein the retrieving of the changes to the policy records comprises using a structured query language (SQL) command, a file retrieval protocol, a batch retrieval process, or a combination thereof, to automatically retrieve the changes to the policy records on a predetermined schedule or upon automatic notification of a presence of a new policy record, an updated policy record, or the combination thereof.

16. The method of claim 1, wherein the changes to the policy records comprise an update to an existing policy or an addition of a new policy.

17. The method of claim 16, wherein the existing policy or the new policy comprises a rule, a regulation, a guideline, a law, a procedure, or a combination thereof.

18. A non-transitory computer-readable medium storing instructions that, when executed by one or more processors of a computer system, cause the computer system to perform operations comprising:
monitoring one or more data stores storing policy records for changes to the policy records;
retrieving, from the one or more data stores, the changes to the policy records;
determining, via a large language model (LLM) using the changes to the policy records as input, a list of one or more entities in an organization that are affected by the changes to the policy records;
deriving, via the LLM using the changes to the policy records as the input, an impact metric for each of the one or more affected entities;
identifying, via a processor using a customizable threshold, for each of the one or more affected entities, that their impact metric exceeds the customizable threshold;
generating, via the LLM, for each of the one or more identified affected entities, an impact assessment report detailing a predicted effect of the changes to the policy records; and
transmitting, via the processor, the impact assessment report to each of the one or more identified affected entities.

19. The non-transitory computer-readable medium of claim 18, wherein determining, via the LLM using the changes to the policy records as the input, the list of the one or more entities comprises operations for:
automatically providing the LLM the changes to the policy records as input;
automatically instructing the LLM, via a LLM prompt, to analyze the changes to the policy records and to derive a potential impact based on the analysis; and
automatically using the potential impact when deriving, via the LLM, the impact metric for each of the one or more affected entities.

20. A system, comprising:
a Large Language Model-based Alerting and Advising System (LAAS) configured to:
monitor one or more data stores storing policy records for changes to the policy records;
retrieve, from the one or more data stores, the changes to the policy records;
determine, via a large language model (LLM) using the changes to the policy records as input, a list of one or more entities in an organization that are affected by the changes to the policy records;
derive, via the LLM using the changes to the policy records as the input, an impact metric for each of the one or more affected entities;
identify, via a processor using a customizable threshold, for each of the one or more affected entities, that their impact metric exceeds the customizable threshold;
generate, via the LLM, for each of the one or more identified affected entities, an impact assessment report detailing a predicted effect of the changes to the policy records; and
transmit, via the processor, the impact assessment report to each of the one or more identified affected entities.
